(19) United States
(12) Patent Application Publication
(10) Pub. No.: US 2006/0202467 A1
(43) Pub. Date: Sep. 14, 2006

(54) Prospective voter ballot recordation and affidavit business form assembly

(75) Inventor: Donna J. Fletcher, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/077,442

(22) Filed: Mar. 10, 2005

(51) Int. Cl. B42D 15/00

(52) U.S. Cl. 283/55; 283/117

(57) ABSTRACT

The present invention includes a multiple part recordation and affidavit form that is used to capture information relating to a prospective registrant or applicant registering to vote and includes a transparent pocket that contains indicia relating to the identity of the registrant or alternatively the status of the voter in his or her application. The form is constructed from a multiple part arrangement of plies that utilizes a carbonless coating enabling the indicia applied on a first layer to transfer to a second or subsequent plies and the face of the envelope.

### CROSS-REFERENCES TO RELATED APPLICATIONS

None.

### FIELD OF THE INVENTION

The present invention is found in the field of business forms assemblies, more particularly combination business forms that are used to capture, record and transfer information for use in voter registrations and making applications for registering to vote. The business form construction of the present invention includes as a first part a multiple part recordation form that is used to receive information and create file and data copies for use such as by a registrar or clerk; a second part which provides a secure document collection piece and a routing envelope that is integrally connected to the document recordation portion; and a third part that creates an identification verification assembly for the user of the form.

### BACKGROUND OF THE INVENTION

There are numerous business form constructions that have been adapted for a variety of purposes and uses. Business forms are commonly or regularly used to capture information, create record and file copies and convey details of a particular transaction for the purpose the form was created.

Multiple part form assemblies are also known in the industry and allow for information that has been recorded on a first ply to be passed through or transferred to a second or successive plies through the use of carbonless coatings or carbon sheets or inter leaves that are interposed between the successive layers. Examples of such multiple part business forms are illustrated by U.S. Pat. Nos. 5,088,962 and 5,334,571.

Business forms with envelope assemblies attached thereto are also generally known and have been used for example for courier waybills in which a multipart form is disposed on an envelope. Shipping information is then recorded on the form, the form parts are separated and then the parts are inserted into the attached envelope for shipping, routing etc. An example of such a construction is depicted in U.S. Pat. Nos. 4,153,163 and 5,002,311.

While there are many form constructions from which to choose to accomplish a particular purpose or objective there continues to be a need to develop new form constructions to meet the needs of our changing society, many of which are a result of changing technology and servicing different or evolving needs in our society. This is particularly true with recent controversies concerning the identification of those registering to vote, discrepancies in registration drives and constant accusations by one party against another with respect to alleged tampering or misreading of the results. Thus, there remains a need to create a business form assembly that provides a chain of custody and secure document retention for the purposes of recording correct registrant or applicant information and maintaining the integrity of the sample during the vote accounting and recordation process.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is a multiple part business form assembly that includes a section for recording information from a voter or someone registering to vote, for example, due to a relocation, achieving a certain age, and the like. The form assembly also includes an envelope for holding documents relating to the status of the individual and a transparent pocket that is used to retain additional documents so as to be able to verify or authenticate the status or identity of the individual that is completing the form assembly.

In one exemplary embodiment of the present invention, a ballot recordation and affidavit form assembly is described and includes a first ply that has first and second transversely extending edges and first and second longitudinally extending sides. The first ply has top and bottom faces and a first length.

The construction of the present embodiment also includes a second ply that has first and second transversely extending edges and first and second longitudinally extending sides. The second ply has top and bottom faces and a second length that is greater than the first length. The second ply has a transversely extending perforation line that runs between the first and second longitudinally extending sides and is disposed closer to one of the transversely extending edges than the other. The second ply is secured to the first ply along one edge by a line of adhesive such that each of the longitudinally extending sides and one of the transversely extending edges of each of the first and second plies are in alignment with one another. The bottom face of the first ply is in an overlying relationship with the top face of the second ply.

In the presently described embodiment, the assembly also includes an envelope construction that has top and bottom plies secured to one another along three sides and has an open end. The envelope construction has a third length that is greater than each of the first and second lengths of the first and second plies. The envelope has upper and lower faces.

The second ply, with the first ply connected thereto, is attached to the envelope construction through a line of adhesive which is disposed beneath the line of adhesive connecting the first and second plies together, such that the second ply bottom face is in an overlying relationship with the upper face of the envelope and the envelope having a closure flap.

The assembly of the presently described embodiment also includes a transparent pocket that is attached to the lower face of the envelope construction. The transparent pocket has first and second longitudinally extending sides and first and second transversely extending edges with the sides of the pocket being in alignment with the sides of the envelope construction. The pocket has a fourth length that is less than each of the first, second and third lengths, and the pocket has an opening that extends transversely to the sides to create a viewable documentation pocket.

The pocket utilized in the presently described embodiment is used to create two transparent plies that are placed in a slightly overlapping relationship so as to create an opening through which documentation can be inserted and then viewed. The first ply is smaller, by for example 5 to 20%, than the second ply and the plies are secured to the lower face of the envelope through U-shaped patterns of adhesive, one pattern being inverted over the other and a space is provided in the area of the overlap.

The envelope is printed with indicia on each face, with the indicia on one face being printed in a first direction and the indicia on the lower face being printed in a second, opposite direction to that of the first printing so as to optimize the use of the envelope construction.

In a still further exemplary embodiment of the present invention method of using a ballot recordation and affidavit form is described and includes the steps of initially providing a business form that has a recordation portion with pre-determined recordation fields and first and second sections. The form assembly further includes an envelope construction and document verification pocket that is provided on a side opposite of the envelope construction to that of the recordation portion. Next, indicia are applied to at least a portion of the recordation fields. Then, one of the sections is separated from the recordation portion and information is inserted into the envelope construction. Finally, document verification information is placed into the verification pocket for viewing and authentication of a voter affidavit.

In a yet still further embodiment of the present invention, a voter recordation and affidavit form for providing secure transmission of documents is provided and includes an envelope that is sealed along three sides and has one open end. The envelope has a closure flap for securing the open end of the envelope.

In the presently described embodiment, a voter affidavit and recordation form is provided and is connected to the envelope along one of the sealed sides. The plies of the form have a carbonless coating that is used to transfer images from the form to an upper face of the envelope. The form also includes pre-determined portions for identifying the individual registering to vote as well as a questionnaire to determine eligibility of the individual.

The construction of this embodiment also includes a voter identification pocket that is affixed to one face of the envelope. The pocket is used to retain information identifying the individual after the form has been completed.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross section of the business form assembly of the present invention;

FIG. 2 provides a front view of the business form assembly;

FIG. 3 illustrates the back of the business form assembly;

FIG. 4 shows a front view of the business form assembly of the present invention with a cut away of the plies showing the underlying areas of the form for capturing copies of the information and the separation line in the second ply of the form construction; and

FIG. 5 depicts a block diagram depicting an exemplary method of using the business form assembly of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The form construction of the present invention is a multiple part voter registration form and verification assembly that provides the district or precinct clerk with a secure means for collecting information from prospective registrants; securely retaining such information for verification purposes. In addition, the form assembly of the present invention provides an authenticity check through the use of a transparent pocket into which identification information or data can be added.

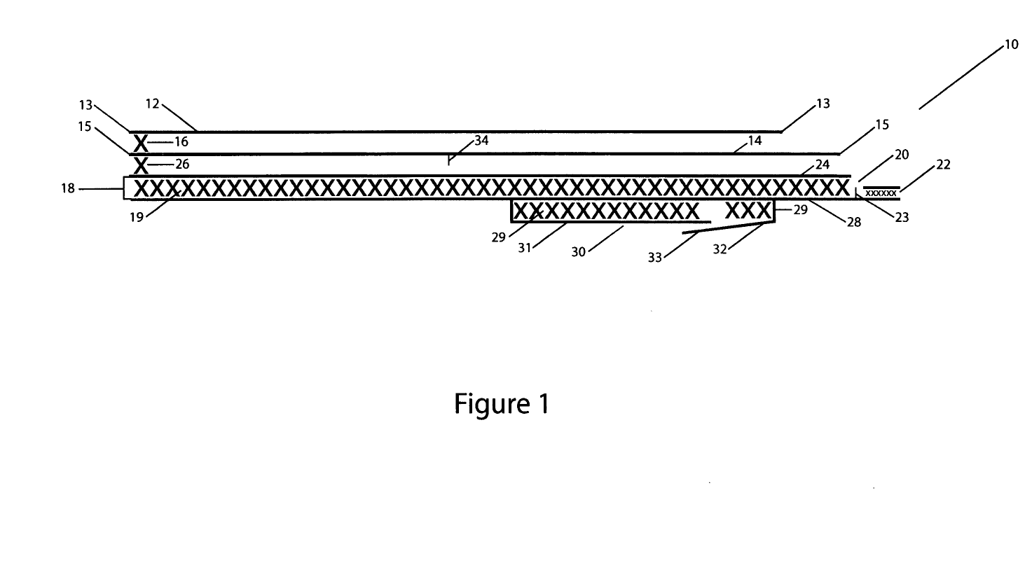

Turning now to FIG. 1 of the present invention, a cross section of the form assembly is provided. The form is generally represented by reference numeral 10 and includes a first ply 12. The first ply 12 is preferably constructed from 20 pound bond cellulosic stock and has dimensions of roughly 8½″ by 11″ giving the first sheet a first length (11 inches) and width. The first ply 12 has first and second longitudinally extending sides and first and second transversely extending edges as can be seen from the subsequent FIGURES described below. The first ply 12 is provided with indicia on one face, as will be described herein, and a carbonless coating, such as a CB coating (coated back) on the second face of the ply to facilitate the transfer of an image imparted to the upper surface of the top ply to the upper surface of a lower sheet through a corresponding CF (coated front) coated sheet as is known by those with skill in the industry.

The form construction 10 also includes a second ply 14 which is again preferably constructed from a 20 pound bond cellulosic based stock and has dimensions of roughly 8½″ by 11½″ which provides the second sheet with a second length (11½ inches) which is slightly longer than the length of the first sheet. The second sheet 14 as can be seen from the subsequent FIGURES is provided with indicia on one face so as to receive complimentary images from the first ply 12 creating a record copy which for example may be provided to the registrant or applicant that completes the form. The second ply 14 has first and second longitudinally extending sides and first and second transversely extending edges. The second sheet is placed in an overlying relationship with the first ply 12, with the exception of one edge 15 of the second ply 14 extending beyond one of the transversely extending edges 13 of the first ply 12 as seen in FIG. 1.

The second ply 14 also has top and bottom faces, with indicia provided on the top face of the ply so that the top face of the second ply 14 is in an adjacent relationship with the bottom face of the first ply 12. The top face of the second ply 14 is provided with a complimentary carbonless coating, a CF coating (coated front) so that the CB coating on the bottom face of the top ply 12 will react with the CB coating on the front face of the second ply 14 to produce an image. The back face of the second ply 14 will also be provided with a carbonless coating so that it can interact with a carbonless coating provided on the upper face of the envelope.

The first ply 12 is connected to the second ply 14 through use of a line of adhesive 16 which is disposed adjacent the end edge of each ply, 13* and 15*, respectively.

The business form assembly 10 of the present invention also includes an envelope construction 18 which includes two plies of material (cellulosic, synthetic films, etc.) that are secured together along three sides by a pattern of adhesive 19 and has an open end 20. The open end 20 of the envelope includes a closure flap 21 that has a pressure sensitive adhesive covered by a removable tape or release liner 22. To seal the open end, the release liner is peeled away and the flap is folded about the opening via fold line 23 bringing the adhesive into contact with the upper face 24 of the envelope.

The envelope 18 is secured to the second ply 14 through the use of a line of adhesive 26 which is provided directly beneath the line of adhesive 16 securing the first ply 12 to the second ply 14. In each instance, the adhesive used to secure the form structure together is a permanent adhesive.

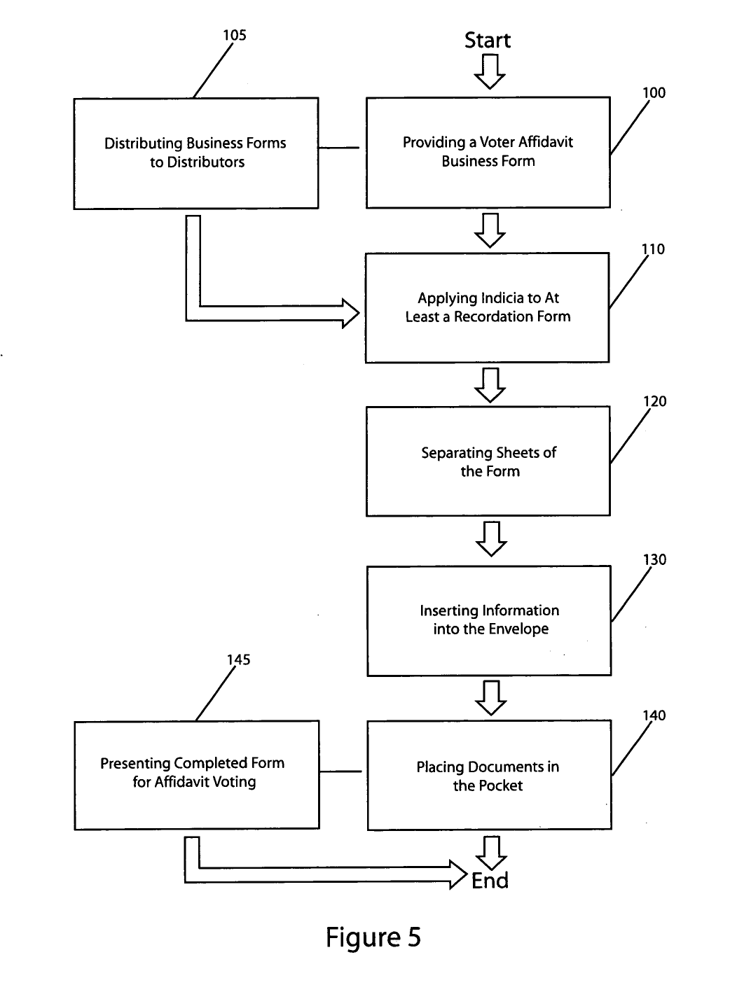

The upper face 24 of the envelope 18 is provided with indicia (see FIG. 5) such that a carbonless coating provided on the lower or bottom face of the second ply 14 and the upper face 24 of the envelope will allow an image created on the first ply 12 to transfer to the upper face 24 of the envelope.

The envelope 18 has a top sheet 27 with a dimension of about 8½″ by 12″ and a bottom sheet 28 with a dimension of about 8½″ by 13″. The bottom sheet 28 has the closure flap with the closure tape 22. The envelope 18 has a third length that is greater than each of the first and second lengths.

FIG. 1 also illustrates the verification pocket 30, which is adhered to the bottom sheet 28 of the envelope construction 18. The pocket 30 is secured by adhesive 29 and 29* and includes first and second transparent plies 31 and 32, respectively. The plies 31 and 32 are positioned so as to create an area of overlap 33 which provides an opening in the construction so that information, such as that relating to the identification of the applicant or registrant, may be inserted in the pocket 30.

The first ply 31 of the pocket 30 has dimensions of about 8½″ by 3½″ and the second ply 32 of the pocket 30 has dimensions of about 8½″ by 2¼″ with the area of the overlap 33 being about ¼″ in length. The pocket 30, as can be seen from the FIGURE, has a fourth length that is less than each of the first, second and third lengths of the first and second plies 12 and 14 and the envelope 18.

Also provided in FIG. 1, is the depiction of a line of weakness or perforation line 34 that appears in the second ply 14 such that the second ply 14 can be separated into first and second portions. One of the portions includes identification information of the voter and the second portion relates to the voter affidavit or other conditions relevant to the registration. The perforation line 34 is preferably located closer to one end edge than the other, that is, the perforation line 34 is not disposed medially of the ply 14.

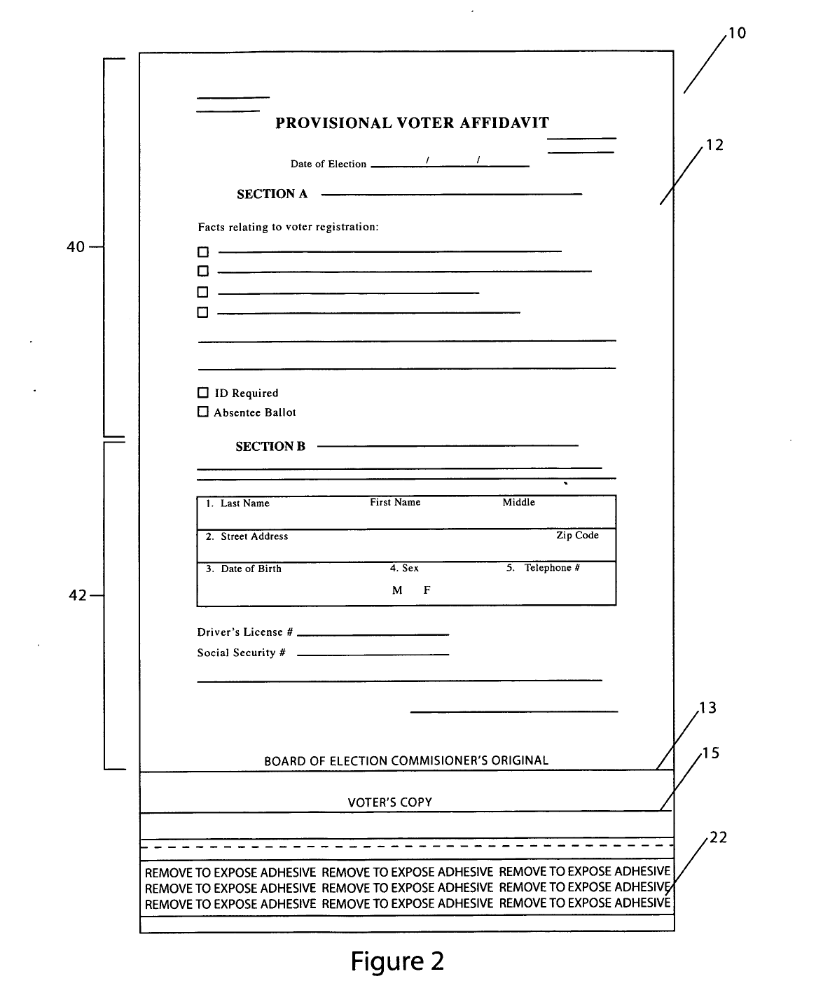

Reference is now directed to FIG. 2, which provides a front view of the form assembly of the present invention. Again, reference numeral 10 is used to generally refer to the form. The first ply 12 is shown with indicia provided in predetermined areas 40 and 42. In the first area 40, voter affidavit information is collected and may include answers to questions, descriptions and other factors relevant to the determination of voter status.

In the second section 42, voter identification information may be collected such as name, address, drivers license information, birth date, social security number and such other information as the voter precinct or district may determine is appropriate. The indicia printed on the face of the first ply 12 is printed in one direction and is legible with the bottom of the form or the edge which has the open end of the envelope 20 at the bottom.

FIG. 2 also further depicts the various lengths of the first and second plies of the envelope but reference to the transversely extending end edges 13 and 15 and the adhesive closure flap 22 of the envelope portion 18.

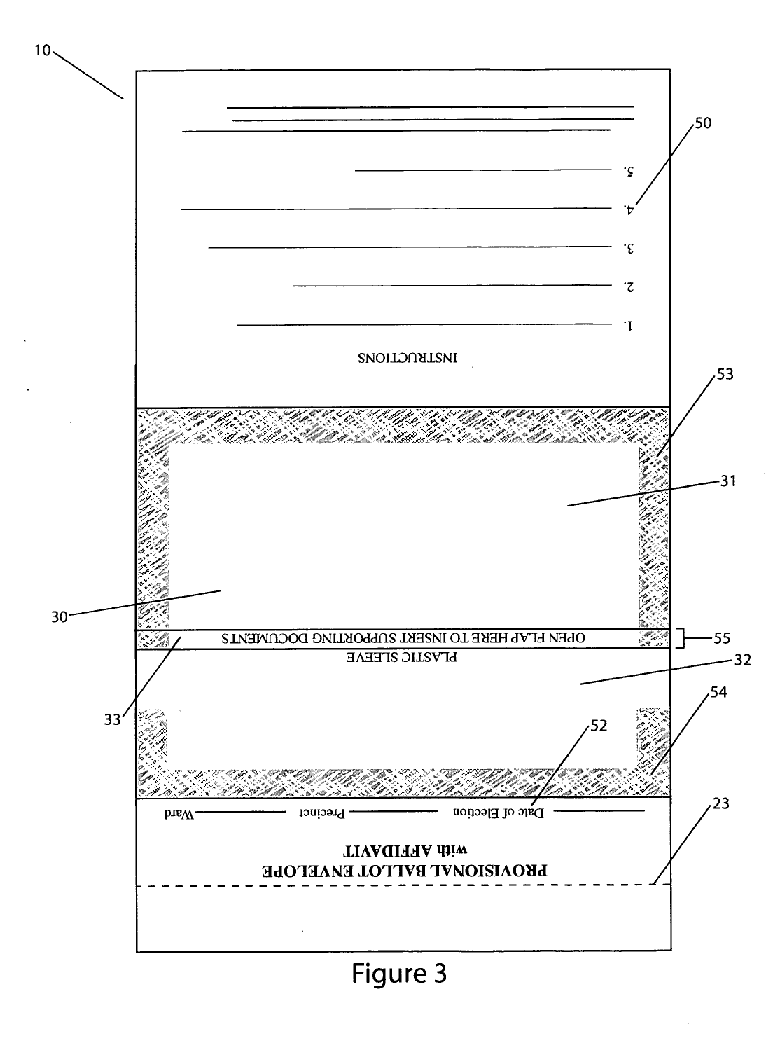

Attention is now directed to FIG. 3 of the present invention, which depicts the backside of the business form construction 10. The lower face of the bottom sheet 28 is printed with indicia 50 and 52 which when the opening of the envelope, here identified by the position of the fold line 23 used to fold the flap over the end, is at the bottom of the form and is inverted or upside down. That is the indicia are printed in second direction that is distinct from the first direction of the printing which appears on the face of the first ply 12 (and subsequent top faces of the second ply and envelope).

FIG. 3 is also presented to show the adhesive patterns that are used to create the verification pocket 30. The first ply 31 is secured to the bottom face of the back ply of the envelope through an inverted U-shaped pattern of adhesive 53. Likewise, the second transparent ply 32 is secured to the back of the envelope through a U-shaped pattern of adhesive 54. The patterns 53 and 54 are spaced a short distance apart so as to create a small space or gap 55 located immediately beneath the overlap 33 that is created by positioning a portion of one of the transparent plies over the other transparent ply. The space or unsecured area of the pocket enables the flap to be easily opened and identification or other documents to be easily inserted in the pocket 30.

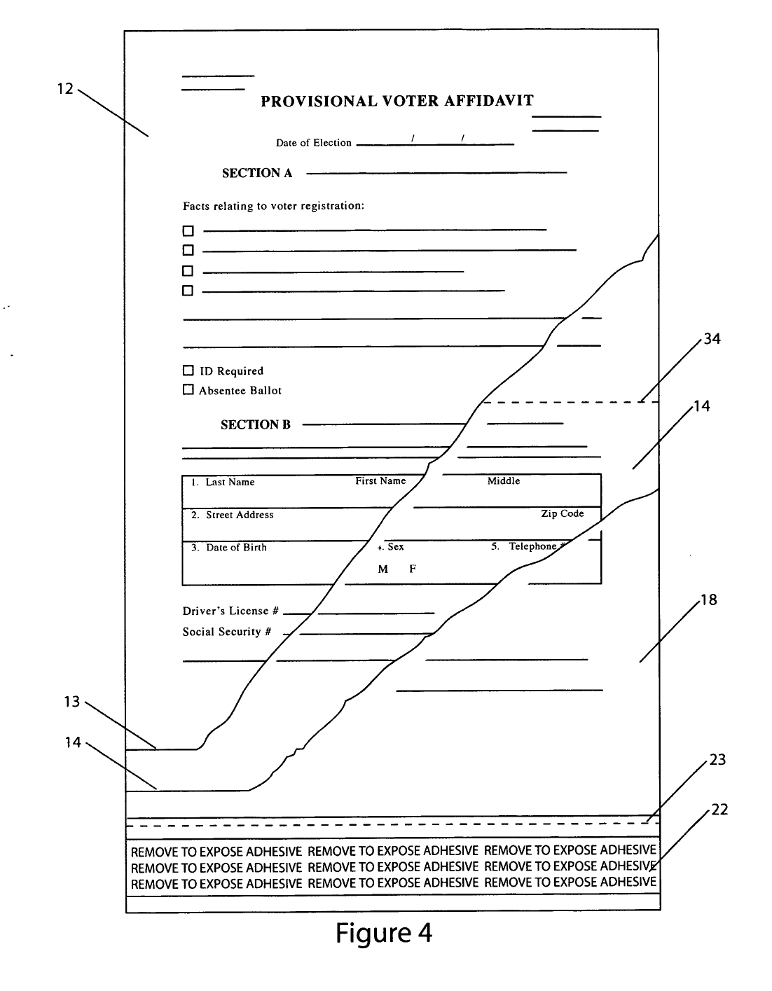

FIG. 4 is used to illustrate the form assembly in which portions of the first ply 12 and second ply 14 have been made to show indicia on the first and second plies as well as the upper face of the envelope. FIG. 4 also shows the perforation line 34 in the second ply 14, which allows the two sections or portions of the second ply to be separated from one another so as to create an identification section and an affidavit section.

FIG. 5 provides a block diagram on an exemplary use of the business form assembly of the present invention. The first step is the provision of a multiple part business form at step 100. The business form is the same construction as has been previously described herein and includes a recordation portion, an envelope and a verification pocket. Next, indicia are applied to one or more sections of the recordation form at step 110. The information will likely be personal information and may include details that have been obtained through responses to a questionnaire, survey and the like. Other printed information may relate to the steps that are necessary in making an application or registration to vote. A supplemental step would of course be distributing a series of business forms at step 105 such as to voting districts or precincts or other locations where such forms may be needed. The first ply will normally be retained with the form construction so as to provide for matching of information that may be inserted into the envelope or obtained from a different location.

Once the information has been added to the form, the sections of the second ply, as described herein are detached from one another at step 120 to create a record copy or a portion to insert in the verification pocket. Then additional information may be inserted into the envelope at step 130 to create a secure enclosure so that the information cannot be tampered with once the envelope has been sealed.

Finally, documents are inserted into the verification pocket at step 140, and the entire package can be presented to election or other officials to verify the registration information or applicant such as at step 145. Of course, the entire envelope or package can be delivered or transported to another location for subsequent verification, processing or the like.

It will thus be seen, according to the present invention a highly advantageous ballot recordation and affidavit business form has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A voter recordation and affidavit form assembly, comprising;
a first ply having first and second transversely extending edges and first and second longitudinally extending sides, said first ply having top and bottom faces and having a first length;
a second ply having first and second transversely extending edges and first and second longitudinally extending sides, said second ply having top and bottom faces and having a second length greater than said first length, and said second ply having a transversely extending perforation line running between said first and second longitudinally extending sides and disposed closer to one of said transversely extending edges;
said second ply is secured to said first ply along one edge by a line of adhesive such that each of said longitudinally extending sides and one of said transversely extending edges of each of said first and second plies are in alignment with one another such that said bottom face of said first ply is in an overlying relationship with said top face of said second ply;
an envelope construction including top and bottom plies secured to one another along three sides and having an open end, said envelope construction having a third length that is greater than each of said first and second lengths, said envelope having upper and lower faces and having a closure flap;
said second ply with said first ply connected thereto is attached to said envelope construction through a line of adhesive disposed beneath said line of adhesive connecting said first and second plies together, such that said second ply bottom face is in an overlying relationship with said upper face of said envelope; and
a transparent pocket attached to said lower face of said envelope construction, said transparent pocket having first and second longitudinally extending sides and first and second transversely extending edges with said sides of said pocket being in alignment with said sides of said envelope construction; said pocket having a fourth length that is less than each of said first, second and third lengths and said pocket having an opening extending transversely to said sides to create a viewable documentation pocket.

2. A ballot recordation and affidavit form as recited in claim 1, wherein said pocket is created from first and second transparent plies that are provided in a slightly overlapping relationship.

3. A ballot recordation and affidavit form as recited in claim 1, wherein said first transparent ply is secured to said lower face of said envelope by an inverted U-shaped pattern of adhesive and said second ply is secured to said lower face of said envelope ply by a U-shaped pattern of adhesive.

4. A ballot recordation and affidavit form as recited in claim 1, wherein said inverted U-shaped pattern of adhesive and said U-shaped pattern of adhesive do not overlap one another.

5. A ballot recordation and affidavit form as recited in claim 1, wherein said first transparent ply has a smaller length than said second transparent ply.

6. A ballot recordation and affidavit form as recited in claim 1, wherein said envelope construction includes a pressure sensitive closure tape to seal said envelope construction after inserting documents.

7. A ballot recordation and affidavit form as recited in claim 1, wherein each of said upper and lower faces of said envelope construction are provided with indicia.

8. A ballot recordation and affidavit form as recited in claim 7, wherein said indicia printed on said upper face of said envelope construction is printed in a first direction and said indicia printed on said lower face of said envelope construction is printed in a second direction opposite from said first direction to facilitate use of said envelope construction.

9. A ballot recordation and affidavit form as recited in claim 1, wherein a perforation line separates said second ply into an affidavit portion and a personal information portion.

10. A ballot recordation and affidavit form as recited in claim 1, wherein each of said first ply, second ply and envelope are provide with a carbonless coating to transfer images.

11. A method of using a ballot recordation and affidavit form, comprising the steps of;
providing a business form having a recordation portion which includes pre-determined recordation fields and first and second sections, an envelope construction and document verification pocket provided on a side opposite of said envelope construction to that of said recordation portion;
applying indicia to at least a portion of said recordation fields;
separating one of said sections from said recordation portion;
inserting information into said envelope construction; and
placing document verification information into said verification pocket for viewing and authentication of a voter affidavit.

12. A method of using a ballot recordation and affidavit form as recited in claim 11, including a further step of presenting the form and envelope for authentication and verification by an official after the step of placing information into the verification pocket.

13. A method of using a ballot recordation and affidavit form as recited in claim 11, including a further step of distributing a plurality of business forms to election districts, precincts and the like after the step of providing a business form.

14. A voter recordation and affidavit form for providing secure transmission of voter registration documents, comprising;
an envelope, sealed along three sides and having one open end, said envelope having a closure flap for securing an open end of said envelope once voter documents are inserted within said envelope;
a multiple part voter affidavit and recordation form connected to said envelope along one of said sealed sides, said form having a carbonless coating for transferring images from said form to an upper face of said envelope, said form having pre-determined portions for identifying an individual registering to vote and a questionnaire to determine eligibility of the individual; and
a voter identification pocket created from at least one transparent sheet having a transversely extending slit, said pocket is affixed to one face of said envelope opposite of said form, said pocket is used to retain information identifying the individual after the form has been completed.
